(19) United States
(12) Patent Application Publication
(10) Pub. No.: US 2008/0123026 A1
(43) Pub. Date: May 29, 2008

(54) DISPLAY DEVICE

(75) Inventors: Jin-Oh KWAG, Suwon-si (KR); Young-Joo PARK, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/772,875

(22) Filed: Jul. 3, 2007

(30) Foreign Application Priority Data
Jul. 6, 2006 (KR) 10-2006-0063356

(51) Int. Cl. G02F 1/1333; G02F 1/13357

(52) U.S. Cl. 349/77; 349/114

(57) ABSTRACT

A display device includes a display panel having a first surface and a second surface facing each other and including a plurality of first pixels displaying an image on the first surface and a plurality of second pixels displaying an image on the second surface, a gate driver supplying gate signals to the first and second pixels, a data driver supplying data signals to the first and second pixels, and a backlight unit irradiating light on the display panel, the first pixels and the second pixels displaying different images. Therefore, different images can be normally realized on both surfaces by independently driving the first pixels and the second pixels.

This application claims priority to Korean Patent Application No. 10-2006-0063356, filed on Jul. 6, 2006 and all the benefits accruing therefrom under 35 U.S.C. §119, the contents of which in its entirety are herein incorporated by reference.

### BACKGROUND OF THE INVENTION

(a) Field of the Invention

The present invention relates to a display device and method thereof. More particularly, the present invention relates to a liquid crystal display (“LCD”) device displaying images in different directions, and a method thereof.

(b) Description of the Related Art

Generally, a liquid crystal display (“LCD”) device includes a liquid crystal panel assembly including two display panels provided with field generating electrodes such as pixel electrodes and a common electrode and a liquid crystal layer interposed there between. The LCD device displays images by applying voltages to the field-generating electrodes to generate an electric field in the liquid crystal layer, which determines orientations of liquid crystal molecules in the liquid crystal layer to adjust polarization of incident light.

Because the LCD device is a light-receiving device that is incapable of self-emitting, light emitted by lamps of a backlight unit separately provided passes through the liquid crystal layer, or external light such as natural light passes through the liquid crystal layer twice by reflection. The former LCD device is called a “transmissive” type of LCD device, and the latter LCD device is called a “reflective” type of LCD device. The reflective type of LCD device is commonly used in medium and small size display devices. Another type of LCD device is a “transflective” or “reflective-transmissive” LCD device that is capable of selectively using light from the backlight unit and external light in response to present circumstances. The transflective LCD device is commonly used in medium and small size display devices.

In the transflective LCD device, each pixel has a transparent electrode and a reflective electrode that are electrically connected to each other. The light emitted from the backlight unit passes through the transparent electrode for use in display, and the external light entering from the opposite side of the backlight unit passes through the reflective electrode for use. Therefore, images are always displayed on only one surface of the liquid crystal panel assembly.

Accordingly, in this case, when the liquid crystal panel assembly is viewed from the other side surface, a reversed image is seen.

When it is desired to display an image on both side surfaces in a mobile phone or the like, two liquid crystal panel assemblies are overlapped so that only the outer surfaces of the two liquid crystal panel assemblies are used for display. Therefore, although an image can be displayed on both sides of such a display device, the thickness is large due to the double liquid crystal panel assemblies.

### BRIEF SUMMARY OF THE INVENTION

The present invention provides a liquid crystal display (“LCD”) device that displays a different image in both directions and that has a small thickness, and a method of displaying images on such an LCD device.

According to exemplary embodiments of the present invention, there is provided a display device including a display panel having a first surface and a second surface facing each other, the display panel including a plurality of first pixels displaying an image on the first surface and a plurality of second pixels displaying an image on the second surface, a gate driver supplying gate signals to the first and second pixels, a data driver supplying data signals to the first and second pixels, and a backlight unit irradiating light on the display panel, the first pixels and the second pixels displaying different images.

The first pixels and the second pixels may display normal images. The first and second pixels may display images in phase, and may be arranged in an alternating fashion.

The display device may further include a plurality of first gate lines connected to the first pixels, and a plurality of second gate lines connected to the second pixels. The gate driver may include a first gate driving circuit applying a gate-on voltage to the first gate lines and a second gate driving circuit applying a gate-on voltage to the second gate lines, the first gate driving circuit and the second gate driving circuit alternately applying the gate-on voltage. The display panel may include a plurality of data lines connected to the first and second pixels, and the data driver may apply a first pixel data voltage and a second pixel data voltage to the data lines in an alternating fashion.

Each first pixel may include a transmissive pixel electrode, and each second pixel may include a reflective pixel electrode. Each first pixel and each second pixel may include a switching device transmitting the data signals in response to the gate signals and a liquid crystal capacitor changing polarization of the light from the backlight unit in response to the data signals, respectively.

According to other exemplary embodiments of the present invention, there is provided a display device, including a display panel having a first surface and a second surface facing each other, and a backlight unit irradiating light from the first surface of the display panel toward the second surface, the display panel displaying a first image created by transmission of light from the backlight unit on the second surface and a second image created by reflection of light from the backlight unit on the first surface. The first image and the second image may be different from each other.

According to still other exemplary embodiments of the present invention, there is provided an LCD device, including a backlight unit providing light, a common electrode, a first pixel electrode facing the common electrode, the first pixel electrode being transparent, a second pixel electrode facing the common electrode, the second pixel electrode including a reflective material, and a display panel including a liquid crystal layer formed between the first and second pixel electrodes and the common electrode, the backlight unit being disposed at a same side as the common electrode relative to the liquid crystal layer. The first pixel electrode and the second pixel electrode may be separated from each other.

According to yet other exemplary embodiments of the present invention, there is provided a display device, including a display panel having a first surface and a second surface facing each other, the display panel including a plurality of pixels, a signal processor generating a first image signal to be displayed on the first surface of the display panel and a second image signal to be displayed on the second surface of the display panel, and a data driver converting the first image signal and the second image signal into a first data voltage and a second data voltage, respectively, to supply the first and second data voltages to different pixels.

The pixels may be arranged in a matrix, and the data driver may supply the first data voltage and the second data voltage to one pixel row in an alternating fashion.

The signal processor may include a first memory unit storing a first set of input image signals inputted from an outside, and a second memory unit storing a second set of input image signals inputted from an outside, wherein the first image signal is generated based on the first set of input image signals, and the second image signal is generated based on the second set of input image signals.

The first and second memory units may output parts of the first and second set of input image signals in an alternating fashion.

According to still other exemplary embodiments of the present invention, there is provided an LCD device, including first and second gate lines arranged in parallel to each other, data lines intersecting the first and second gate lines, a first thin film transistor (“TFT”) connected to the first gate line and a data line, a second TFT connected to the second gate line and the data line connected to the first TFT, a first pixel electrode connected to the first TFT, a second pixel electrode connected to the second TFT and including a reflective electrode, a common electrode facing the first and second pixel electrodes, and a liquid crystal layer formed between the first and second pixel electrodes and the common electrode.

The first and second pixel electrodes may be disposed between the first gate line and the second gate line, and arranged in a data line direction.

The LCD device may further include a storage electrode line overlapping the first and second pixel electrodes, and a passivation layer formed between the reflective electrode and the second TFT, wherein the passivation layer has an uneven surface. The second pixel electrode may include a transparent electrode disposed below the reflective electrode. The first pixel electrode and the second pixel electrode may receive a data voltage obtained from different image information.

### BRIEF DESCRIPTION OF THE DRAWINGS

The present invention will become more apparent by further describing exemplary embodiments thereof with reference to the accompanying drawings, in which:

FIG. 1 is a block diagram of an exemplary liquid crystal display (“LCD”) device according to an exemplary embodiment of the present invention;

FIG. 2 is an equivalent circuit diagram of one exemplary pixel in an exemplary LCD device according to an exemplary embodiment of the present invention;

FIG. 3 is a layout view of an exemplary liquid crystal panel assembly according to an exemplary embodiment of the present invention;

FIG. 4 is a cross-sectional view of the exemplary liquid crystal panel assembly of FIG. 3 taken along line IV-IV;

FIG. 5 is a cross-sectional view of the exemplary liquid crystal panel assembly of FIG. 3 taken along line V-V;

FIG. 6 is a block diagram of an exemplary signal processor according to an exemplary embodiment of the present invention;

FIG. 7 is a block diagram of an exemplary gate driver according to an exemplary embodiment of the present invention;

FIG. 8 is a circuit diagram of one exemplary stage of the exemplary gate driver as shown in FIG. 7; and,

FIG. 9 is a signal waveform diagram showing the operation of the exemplary gate driver of FIG. 8.

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Now, display devices and methods thereof according to exemplary embodiments of this invention will be described in detail with reference to the accompanying drawings.

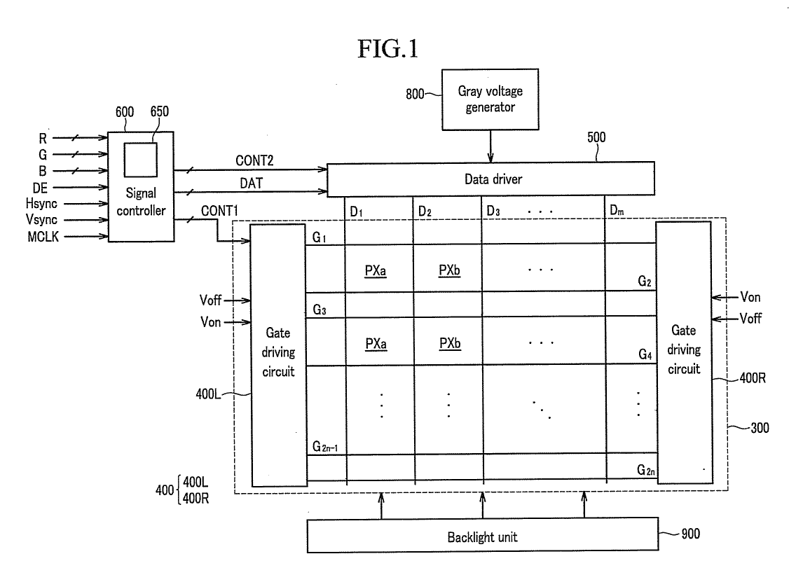

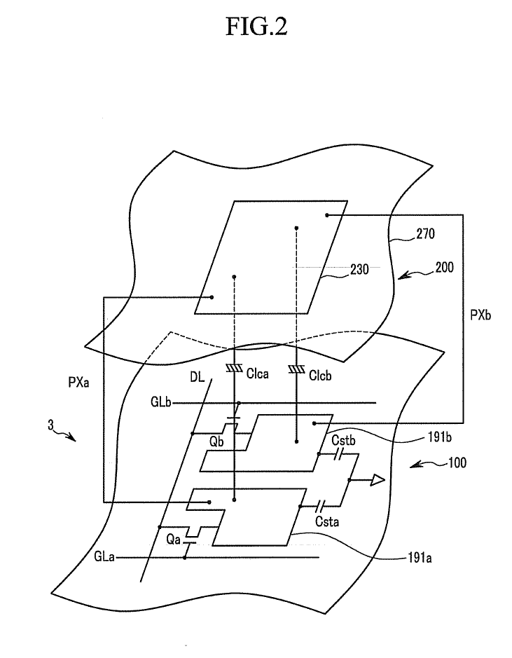

FIG. 1 is a block diagram of an exemplary liquid crystal display (“LCD”) device according to an exemplary embodiment of the present invention, and FIG. 2 is an equivalent circuit diagram of one exemplary pixel in an exemplary LCD device according to an exemplary embodiment of the present invention.

As shown in FIG. 1, an LCD device according to an exemplary embodiment of the present invention includes a liquid crystal panel assembly 300, a gate driver 400, a data driver 500, a gray voltage generator 800, a backlight unit 900, and a signal controller 600.

In the equivalent circuit view, the liquid crystal panel assembly 300 includes a plurality of signal lines G₁-G₂ₙ and D₁-Dₘ and a plurality of first and second pixels PXa and PXb connected thereto and arranged substantially in a matrix. The liquid crystal panel assembly 300, in the structural view shown in FIG. 2, includes lower and upper panels 100 and 200, also referred to as TFT array panel and common electrode panel, respectively, facing each other and a liquid crystal layer 3 interposed there between.

The signal lines G₁-G₂ₙ and D₁-Dₘ include a plurality of first and second gate lines G₁-G₂ₙ that transmit gate signals (called scanning signals) and a plurality of data lines D₁-Dₘ that transmit data signals. The gate lines G₁-G₂ₙ extend substantially in a row direction, a first direction, and are substantially parallel to each other, while the data lines D₁-Dₘ extend substantially in a column direction, a second direction, and are substantially parallel to each other. The first direction may be substantially perpendicular to the second direction.

The first pixel PXa and the second pixel PXb display images on opposite surfaces of the liquid crystal panel assembly 300. For instance, if the first pixel PXa displays an image on the rear surface of the liquid crystal panel assembly 300, the second pixel PXb displays an image on the front surface thereof, or vice versa.

The first and second pixels PXa and PXb forming a pair are connected to a pair of gate lines GLa and GLb, respectively, and are both connected to one data line DL. Each pixel PXa/PXb includes a switching element Qa/Qb connected to the signal lines GLa/GLb and DL, a liquid crystal capacitor Clca/Clcb, and a storage capacitor Csta/Cstb.

The switching element Qa/Qb, such as a thin film transistor (“TFT”), is provided on the lower panel 100 and has three terminals: a control terminal, such as a gate electrode, connected to the gate line GLa/GLb, an input terminal, such as a source electrode, connected to the data line DL, and an output terminal, such as a drain electrode, connected to the liquid crystal capacitor Clca/Clcb and the storage capacitor Csta/Cstb.

The liquid crystal capacitor Clca/Clcb includes a pixel electrode 191a/191b provided on the lower panel 100 and a common electrode 270 provided on the upper panel 200 as two terminals. The liquid crystal layer 3 disposed between the two electrodes 191a/191b and 270 functions as a dielectric. The pixel electrode 191a/191b is connected to the switching element Qa/Qb, and the common electrode 270 is supplied with a common voltage Vcom and covers an entire surface, or substantially an entire surface, of the upper panel 200. Alternatively, the common electrode 270 may be provided on the lower panel 100, and at least one of the two electrodes 191a/191b and 270 may have a shape of a bar or a stripe. The first pixel electrode 191a may be a transparent transmissive electrode, and the second pixel electrode 191b may be a reflective electrode.

The storage capacitor Csta/Cstb is an auxiliary capacitor for the LC capacitor Clca/Clcb. The storage capacitor Clca/Clcb includes the pixel electrode 191a/191b and a separate signal line, which is provided on the lower panel 100, overlaps the pixel electrode 191a/191b via an insulator, and is supplied with a predetermined voltage such as the common voltage Vcom.

For color display, each pixel PXa and PXb uniquely represents one color in a set of colors, such as primary colors, (i.e., spatial division) or each pixel PX sequentially represents the colors in turn (i.e., temporal division) such that a spatial or temporal sum of the colors is recognized as a desired color. An example of a set of the colors includes red, green, and blue colors. FIG. 2 shows an example of the spatial division in which the pair of pixels PXa and PXb includes a color filter 230 representing one of the colors in the set of colors in an area of the upper panel 200 facing the pair of pixel electrodes 191a and 191b. Alternatively, the color filter 230 is provided on or under the pixel electrodes 191a/191b on the lower panel 100.

At least one polarizer (not shown) is attached to an outer surface of the liquid crystal panel assembly 300. For example, a first polarized film and a second polarized film are disposed on the lower and upper panels 100, 200, respectively. The first and second polarized films may adjust a transmission direction of light externally provided into the lower and upper panels 100, 200, in accordance with an aligned direction of the liquid crystal layer 3. The first and second polarized films may have first and second polarized axes thereof substantially perpendicular to each other.

As above, the first pixel PXa and the second pixel PXa may be alternately arranged in rows, and the first pixel PXa and second pixel PXb of an adjacent column may be arranged in a reverse order.

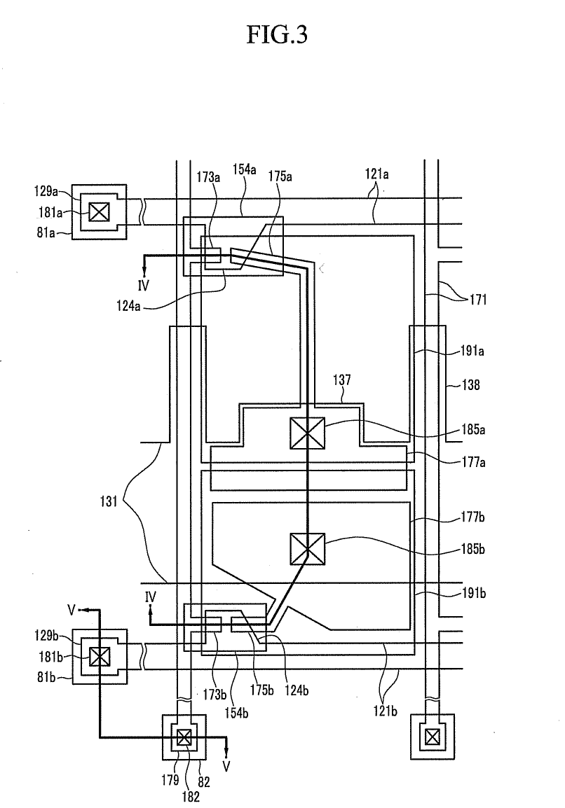

Now, a structure of the liquid crystal panel assembly 300 according to exemplary embodiments of the present invention will be described with reference to FIGS. 3 to 5.

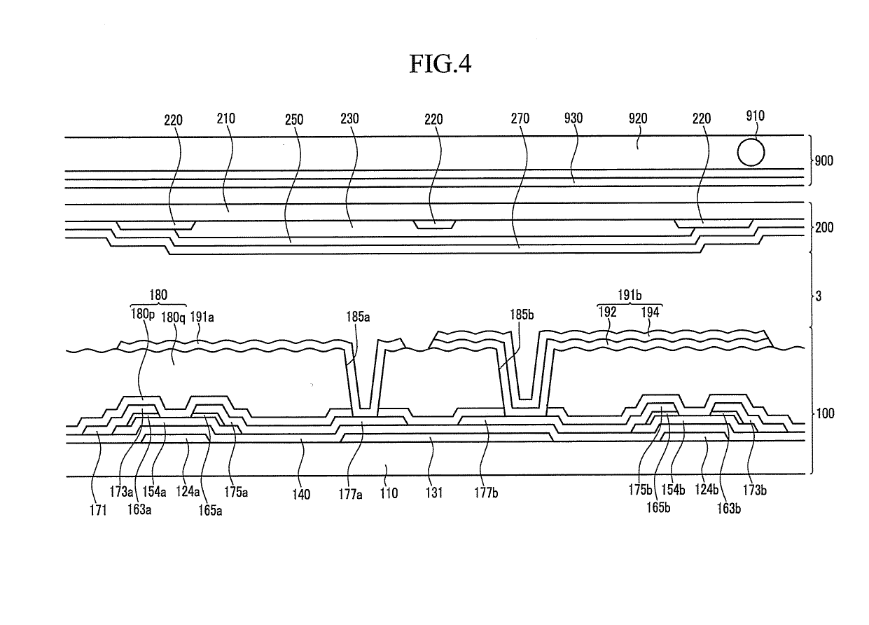

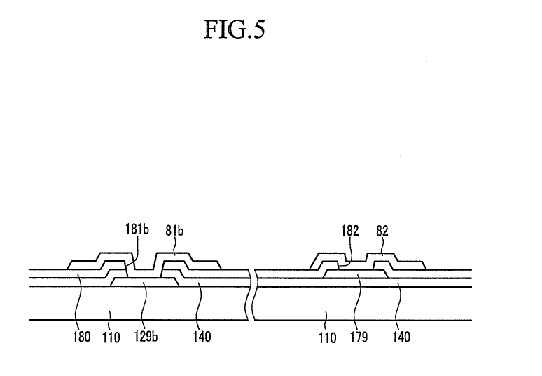

FIG. 3 is a layout view of an exemplary liquid crystal panel assembly according to an exemplary embodiment of the present invention, FIG. 4 is a cross-sectional view of the exemplary liquid crystal panel assembly of FIG. 3 taken along line IV-IV, and FIG. 5 is a cross-sectional view of the exemplary liquid crystal panel assembly of FIG. 3 taken along line V-V.

The liquid crystal panel assembly 300 according to the present exemplary embodiment includes a TFT array panel 100 and a common electrode panel 200 facing each other, and a liquid crystal layer 3 interposed between the two panels 100 and 200.

Firstly, the TFT array panel 100 will be described.

A plurality of first and second gate lines 121a and 121b and a plurality of storage electrode lines 131 are disposed on an insulating substrate 110 made of transparent glass or the like.

The gate lines 121a and 121b mainly extend in a transverse direction, the first direction, and are arranged in turn. The first gate lines 121a include a plurality of first gate electrodes 124a protruding downward, toward the second gate lines 121b, and a plurality of end portions 129a having a wide area for connection to other layers or external apparatuses. The second gate lines 121b are disposed below the first gate lines 121a and include a plurality of second gate electrodes 124b protruding upward, toward the first gate lines 121a, and a plurality of end portions 129b having a wide area for connection to other layers or external apparatuses. A gate driving circuit (not shown), such as gate driver 400 from FIG. 1, for generating gate signals may be mounted on a flexible printed circuit film (not shown), which may be attached to a substrate 110, directly mounted on the substrate 110, or integrated onto the substrate 110. The gate lines 121a and 121b may extend to be connected to a gate driving circuit that may be integrated on the substrate 110.

The storage electrode lines 131 are supplied with a predetermined voltage, and extend almost parallel to the gate lines 121a and 121b. Each of the storage electrode lines 131 is disposed between the first gate lines 121a and the second gate lines 121b, and may be disposed closer to the second gate lines 121b than to the first gate lines 121a. The storage electrode lines 131 include projections 137 and 138 protruding upward toward the first gate lines 121a. While a particular arrangement is illustrated and described, the shapes and arrangement of the storage electrode lines 131 may be modified in various manners.

The gate lines 121a and 121b and the storage electrode lines 131 may be made of an aluminum-based metal such as aluminum (Al) and an aluminum alloy, a silver-based metal such as silver (Ag) and a silver alloy, a copper-based metal such as copper (Cu) and a copper alloy, a molybdenum-based metal such as molybdenum (Mo) and a molybdenum alloy, chromium (Cr), titanium (Ti), or tantalum (Ta). However, the gate lines 121a and 121b and the storage electrode lines 131 may have a multi-layered structure including two conductive layers (not shown) having different physical properties. In such a multi-layered structure, one of the two conductive layers may be made of a metal having low resistivity, for example an aluminum-based metal, a silver-based metal, and a copper-based metal, in order to reduce signal delay or voltage drop, and the other conductive layer in such a multi-layered structure may be made of a material having good contact characteristics to other materials, particularly to indium tin oxide (“ITO”) and indium zinc oxide (“IZO”), such as a molybdenum-based metal, chromium, titanium, and tantalum. Examples of the multi-layered structure may include a combination of a lower chromium layer and an upper aluminum (alloy) layer and a combination of a lower aluminum (alloy) layer and an upper molybdenum (alloy) layer. While particular examples have been described, the gate lines 121a and 121b and the storage electrode lines 131 may be made of various metals and conductive materials not explicitly listed herein.

The side surfaces of the gate lines 121a and 121b and the storage electrode lines 131 may be slanted with respect to a surface of the substrate 110 so as to form an angle in the range of about 30° to about 80° with respect to the substrate 110.

A gate insulating layer 140 made of a silicon nitride (SiNx), silicon oxide (SiOx), or the like is formed on the gate lines 121a and 121b and the storage electrode lines 131 and may further be formed on exposed surfaces of the substrate 110.

A plurality of first and second island-type semiconductors 154a and 154b made of hydrogenated amorphous silicon (“a-Si”) or polysilicon are formed on the gate insulating layer 140, and overlapping the gate electrodes 124a and 124b, respectively.

A plurality of pairs of first island-type ohmic contact members 163a and 165a are formed over the first semiconductors 154a, and a plurality of pairs of second island type ohmic contact members 163b and 165b are formed over the second semiconductors 154b. The ohmic contact 163a, 163b, 165a, and 165b are made of a silicide, or an n+ hydrogenated a-Si or the like that is heavily doped with n-type impurities.

The side surfaces of the semiconductors 154a and 154b and the ohmic contact members 163a, 163b, 165a, and 165b may be slanted with respect to the surface of the substrate 110 to form an angle in the range of about 30° to about 80° with respect to the substrate 110.

A plurality of data lines 171 and a plurality of first and second drain electrodes 175a and 175b are formed on the ohmic contact members 163a, 163b, 165a, and 165b and the gate insulating layer 140.

The data lines 171 mainly extend in a longitudinal direction, the second direction, to intersect the gate lines 121a and 121b and the storage electrode lines 131, and transmit the data signals. Each of the data lines 171 has a plurality of first and second source electrodes 173a and 173b that extend toward the gate electrodes 124a and 124b, and end portions 179 that have enlarged widths for connection to other layers or external apparatuses. A data driving circuit (not shown), such as data driver 500 shown in FIG. 1, for generating data signals may be mounted on a flexible printed circuit film (not shown), which may be attached to the substrate 110, directly mounted on the substrate 110, or integrated onto the substrate 110. The data lines 171 may extend to be connected to a data driving circuit that may be integrated on the substrate 110.

The first and second drain electrodes 175a and 175b are separated from the data lines 171 and disposed opposite the source electrodes 173a and 173ba with respect to the first and second gate electrodes 124a and 124b. Each of the drain electrodes 175a and 175b includes an end portion having an enlarged portion 177a/177b and a bar-shaped end portion. The enlarged portion 177a/177b has a large area and overlaps the storage electrode lines 131, and the bar-shaped end portion is disposed opposite the source electrodes 173a and 173b. The enlarged portion 177a of the first drain electrode 175a may at least partially overlap the projection 137 of the storage electrode lines 131.

One gate electrode 124a/124b, one source electrode 173a/173b, and one drain electrode 175a/175b together with the semiconductor 154a/154b constitute one TFT, and channels of the TFT are formed on the semiconductor 154a/154b between the source electrode 173a/173b and the drain electrode 175a/175b.

The data lines 171 and the drain electrodes 175a and 175b are preferably made of a molybdenum-based metal, chromium, a refractory metal such as tantalum and titanium, or an alloy thereof, and may have a multi-layered structure that includes a refractory metal layer (not shown) and a low resistance conductive layer (not shown). Examples of the multi-layered structure include a two-layered structure of a lower chromium or molybdenum (alloy) layer and an upper aluminum (alloy) layer, and a three-layered structure of a lower molybdenum (alloy) layer, an intermediate aluminum (alloy) layer, and an upper molybdenum (alloy) layer. While particular examples are described, the data lines 171 and the drain electrodes 175a and 175b may be made of various metals and conductive materials not explicitly listed herein.

The side surfaces of the data lines 171 and the drain electrodes 175a and 175b are preferably slanted to form an angle ranging from about 30° to about 80° with respect to the surface of the insulating substrate 110.

The ohmic contact members 163a, 163b, 165a, and 165b are interposed only between the underlying semiconductors 154a and 154b and the overlying data lines 171 and drain electrodes 175a and 175b, and have a function of reducing the contact resistance between the semiconductors 154 and the overlying layers. The semiconductors 154a and 154b have exposed portions that are not covered with the data lines 171 and the drain electrodes 175a and 175b, for example portions disposed between the source electrodes 173a and 173b and the drain electrodes 175a and 175b.

A passivation layer 180 is formed on the data lines 171, the drain electrodes 175a and 175b, and the exposed portions of the semiconductors 154, and may be further formed on exposed portions of the gate insulating layer 140. The passivation layer 180 includes a lower film 180p made of an inorganic insulating material such as silicon nitride and silicon oxide and an upper film 180q made of an organic material. The upper passivation film 180q preferably has a dielectric constant less than 4.0, and it may have photosensitivity and an uneven surface. However, the passivation layer 180 may have a single-layered structure made of an inorganic insulating material or an organic insulating material.

In the passivation layer 180, a plurality of contact holes 182, 185a, and 185b that expose end portions 179 of the data lines 171 and the drain electrodes 175a and 175b, respectively, are formed. A plurality of contact holes 181a and 181b that expose the end portions 129a and 129b of the gate lines 121a and 121b, respectively, are formed in the passivation layer 180 and the gate insulating layer 140.

On the passivation layer 180, a plurality of first and second pixel electrodes 191a and 191b and a plurality of contact assistance members 81a, 81b, and 82 are formed.

The first pixel electrode 191a and the second pixel electrode 191b are curved along the unevenness of the passivation layer 180, and are separated from each other. The first pixel electrode 191a is also formed within the contact hole 185a and on the portion of the enlarged portion 177a of the first drain electrode 175a exposed through the contact hole 185a. The second pixel electrode 191b includes a transparent electrode 192 and a reflective electrode 194 thereon. The transparent electrode 192 may be omitted. The second pixel electrode 191b is also formed within the contact hole 185b and on the portion of the enlarged portion 177b of the second drain electrode 175b exposed through the contact hole 185b.

The first pixel electrode 191a and the transparent electrode 192 are made of a transparent conductive material such as ITO and IZO, and the reflective electrode 194 is made of a reflective conductive material such as aluminum, silver, chromium, and an alloy thereof. However, the reflective electrode 194 may have a two-layered structure of an upper film (not shown) made of a low resistance reflective material such as aluminum, silver, or an alloy thereof, and a lower film (not shown) made of a material having good contact characteristics to ITO and IZO, such as a molybdenum-based metal, chromium, tantalum, and titanium.

The first pixel electrode 191a is physically and electrically connected through the contact hole 185a to the enlarged portion 177a of the first drain electrode 175a to receive data voltages from the first drain electrodes 175a. The second pixel electrode 191b is physically and electrically connected through the contact hole 185b to the enlarged portion 177b of the second drain electrode 175b to receive data voltages from the second drain electrodes 175b. The first/second electrode 191a/191b supplied with the data voltages generates an electric field together with a common electrode 270 of a common electrode panel 200 supplied with a common voltage, so that alignment of the liquid crystal molecules of the liquid crystal layer 3 between the two electrodes 191a/191b and 270 can be determined. Polarization of light passing through the liquid crystal layer 3 changes according to the determined alignment of the liquid crystal molecules. The first and second pixel electrodes 191a and 191b and the common electrode 270 constitute the liquid crystal capacitors to sustain the applied voltages even when the TFTs turn off.

The transflective type of liquid crystal panel assembly 300 including the TFT array panel 100, the common electrode panel 200, the liquid crystal layer 3, and so on can be divided into a transmissive region and a reflective region that are defined by the first pixel electrode 191a and the second pixel electrode 191b, respectively.

In the transmissive region, light incident from the front surface of the liquid crystal panel assembly 300, i.e., an outer surface of the common electrode panel 200, passes through the liquid crystal layer 3 to exit toward the rear surface thereof, i.e., an outer surface of the TFT array panel 100, thereby performing display on the rear surface of the liquid crystal panel assembly 300. In the reflective region, light entering from the front surface thereof, passes through the common electrode panel 200, enters into the liquid crystal layer 3, is reflected by the second pixel electrode 191b, and passes through the liquid crystal layer 3 and the common electrode panel 200 again to exist toward the front surface thereof, thereby performing display on the front surface of the liquid crystal panel assembly 300. A curve, that is a non-planar surface, of the second pixel electrode 191b improves the reflection efficiency of light.

The first and second pixel electrodes 191a and 191b and the enlarged portions 177a and 177b of the first and second drain electrodes 175a and 175b connected thereto constitute storage capacitors that overlap the storage electrode lines 131 including the projections 137 and 138, and intensify the voltage sustaining capability of the liquid crystal capacitors. Some parts of the storage electrode lines 131 are overlapped by the enlarged portion 177a of the first drain electrode 175a, and the other parts thereof are overlapped by the enlarged portion 177b of the second drain electrode 175b. As above, storage capacitors of two pixels PXa and PXb having the first pixel electrode 191a or the second pixel electrode 191b are formed via one storage electrode line 131, thereby ensuring transmittance.

The contact assistance members 81a, 81b, and 82 are connected through the contact holes 181a, 181b, and 182 to the end portions 129a and 129b of the gate lines 121a and 121b and the end portions 179 of the data lines 171, respectively. The contact assistance members 81a, 81b, and 82 have a function of aiding the adhesion of the end portions 129a and 129b of the gate lines 121a and 121b and the end portions 179 of the data lines 171 to external apparatuses, and protecting these portions.

Now, the common electrode panel 200 will be described.

A light-blocking member 220 is formed on a dielectric substrate 210 made of transparent glass, plastic, or the like. The light-blocking member 220, which may also be termed a black matrix, defines a plurality of openings that face the first pixel electrode 191a and the second pixel electrode 191b and prevents light leakage between the first pixel electrode 191a and the second pixel electrode 191b.

A plurality of color filters 230 is formed on the substrate 210. Most portions of each of the color filters 230 are disposed in the openings surrounded by the light-blocking member 220. The color filters 230 may extend along the first pixel electrodes 191a and the second pixel electrode 191b in a longitudinal direction to form stripes. Each of the color filters 230 can represent one color in a set of colors such as red, green, and blue.

An overcoat 250 is formed on the color filters 230 and the light-blocking member 220. The overcoat 250 may be made of an insulating material, such as an organic insulating material, and it protects the color filters 230, prevents the color filters 230 from being exposed, and provides a flat surface. Alternatively, the overcoat 250 may be omitted.

A common electrode 270 is formed on the overcoat 250. The common electrode 270 is preferably made of a transparent conductive material such as ITO and IZO.

An alignment film (not shown) for aligning the liquid crystal layer 3 is coated on inner or outer surfaces of the panels 100 and 200. Polarizers (not shown) are provided on inner or outer surfaces of the panels 100 and 200.

The liquid crystal layer 3 may be vertically or horizontally aligned.

The liquid crystal panel assembly 300 further includes a plurality of elastic spacers (not shown) for supporting the TFT array panel 100 and the common electrode panel 200 to form a gap there between.

The liquid crystal panel assembly 300 may further include a sealant (not shown) for bonding the TFT array panel 100 and the common electrode panel 200. The sealant is disposed at an edge of the common electrode panel 200.

Referring to FIG. 1 again, the gray voltage generator 800 generates two grayscale voltage sets (reference grayscale sets) corresponding to transmittance of pixels PXa and PXb. One of the two sets has a positive value with respect to the common voltage Vcom, and the other set has a negative value with respect to the common voltage Vcom.

The gate driver 400 includes first and second gate driving circuits 400L and 400R, and the gate driving circuits 400L and 400R are connected to the gate lines G₁-G₂ₙ of the liquid crystal panel assembly 300 to apply gate signals formed in a combination of a gate-on voltage Von and a gate-off voltage Voff to the gate lines G₁-G₂ₙ.

The first gate driving circuit 400L is disposed at a left side of the liquid crystal panel assembly 300 and applies gate signals to first gate lines G₂ⱼ₋₁(j=1, 2, . . . n) (GLa of FIG. 2) connected to the first pixels PXa. The first gate lines G₂ⱼ₋₁ may also be referred to as odd numbered gate lines. The second gate driving circuit 400R is disposed at a right side of the liquid crystal panel assembly 300 and applies gate signals to second gate lines G₂ⱼ (GLb of FIG. 2) connected to the second pixels PXb. The second gate lines G₂ⱼ may also be referred to as even numbered gate lines. The first gate driving circuit 400L and the second gate driving circuit 400R apply a gate-on voltage Von, starting from the gate line disposed on the uppermost side of the liquid crystal panel assembly 300, and alternately output the gate-on voltage Von.

In contrast, the gate driver 400 may be comprised of one gate driving circuit, and may sequentially output a gate-on voltage Von to the first gate lines G₂ⱼ₋₁ and the second gate lines G₂ⱼ.

The data driver 500 is connected to the data lines D₁-Dₘ of the liquid crystal panel assembly 300 to select a gray voltage from the gray voltage generator 800 and apply it to the data lines D₁-Dₘ as a data signal.

The backlight unit 900 is, as shown in FIG. 4, disposed to be close to the common electrode panel 200 rather than the TFT array panel 100 of the liquid crystal panel assembly 300, to irradiate light toward the TFT array panel 100 from the common electrode panel 200. The backlight unit 900 may include a light source 910 for generating light, a light conducting plate 920 for guiding and diffusing light from the light source toward the liquid crystal panel assembly 300, and an optical sheet 930. The light conducting plate 920 may have a shape similar to that of the common electrode panel 200, and the optical sheet 930 may be disposed between the light conductive plate 920 and the common electrode panel 200. A fluorescent lamp or light emitting diode (“LED”) may be used as the light source 910, and may be arranged at a side of the light conductive plate 920.

The signal controller 600 controls operations of the gate driver 400, the data driver 500, and the like. The signal controller 600 further includes a signal processor 650 for processing input image signals R, G, and B supplied from the outside of the liquid crystal panel assembly 300.

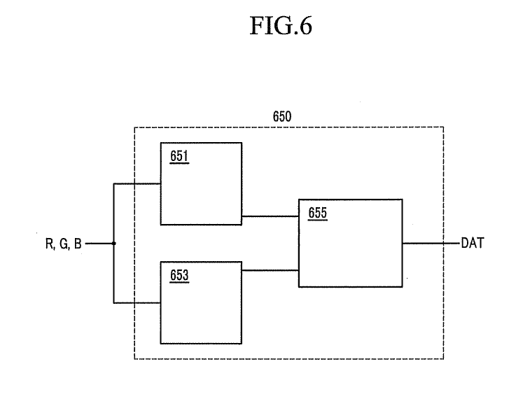

Now, the signal processor 650 will be described with reference to FIG. 6.

FIG. 6 is a block diagram of an exemplary signal processor according to an exemplary embodiment of the present invention.

Referring to FIG. 6, the signal processor 650 according to an exemplary embodiment of the present invention includes a first memory unit 651, a second memory unit 653, and a signal alignment unit 655, and generates output image signals DAT based on input image signals R, G, and B.

The first and second memory units 651 and 653 each include a memory for storing image signals R, G, and B of one frame. The first and second memory units 651 and 653 receive front display input image signals R, G, and B and rear display input image signals R, G, and B every other frame. The first memory unit 651 may receive front display input image signals R, G, and B and the second memory unit 653 may receive rear display input image signals R, G, and B, or vice versa. The front display input image signals R, G, and B are related to the second pixel PXb, i.e., the second pixel electrode 191b in FIGS. 3 to 5 that includes the reflective electrode 194, and the rear display input image signals R, G, and B are related to the first pixel PXa, i.e., the first pixel electrode 191a in FIGS. 3 to 5.

The signal alignment unit 655 determines whether the input image signals R, G, and B stored in each of the memory units 651 and 653 are signals related to the front surface of the liquid crystal panel assembly 300 or signals related to the rear surface of the liquid crystal panel assembly 300, and reads input image signals R, G, and B for one pixel row from the first and second memory units 651 and 653 alternately.

The signal alignment unit 655 outputs the input image signals R, G, and B read out from the first and second memory units 651 and 653 alternately in the order of reading, and the thusly outputted image signals become output image signals DAT.

In an alternative embodiment, the input image signals R, G, and B may be inputted in the first and second memory units 651 and 653 without being set as to whether they are front display input image signals or rear display input image signals. In this case, the signal alignment unit 655 may set the input image signals R, G, and B stored in one side of the first and second memory units 651 and 653 as front display input image signals and the input image signals R, G, and B stored in the other side as rear display input image signals for outputting them.

Each of the drivers 400, 500, 600, and 800 may be directly mounted in a form of at least one integrated circuit (“IC”) chip on the liquid crystal panel assembly 300, may be attached in a form of a tape carrier package (“TCP”) on a flexible printed circuit (“FPC”) film (not shown) in the liquid crystal panel assembly 300, or may be mounted on a separate printed circuit board (“FCB”) (not shown). Alternatively, these drivers 400, 500, 600, and 800 together with the signal lines G₁-G₂ₙ and D₁-Dₘ and the TFT switching elements Qa and Qb may be directly mounted on the liquid crystal panel assembly 300. Further, the drivers 400, 500, 600, and 800 may be integrated as a single chip. In this case, at least one of them or at least one circuit device constituting them may be located at the outside of the single chip.

Now, the operation of the LCD device will be described.

The signal controller 600 is supplied with input image signals R, G, and B and input control signals controlling the display thereof from an external graphics controller (not shown). The input image signals R, G, and B contain luminance information of each pixel PXa/PXb, and the luminance has a predetermined number, for example, 1024 (=2¹⁰), 256 (=2⁸), or 64 (=2⁶) gray scales. The input control signals include, for example, a vertical synchronization signal Vsync, a horizontal synchronization signal Hsync, a main clock signal MCLK, and a data enable signal DE.

In response to the input image signals R, G, and B and the input control signals, the signal controller 600 processes the input image signals R, G, and B suitably for operation of the liquid crystal panel assembly 300 and generates output image signals DAT, gate control signals CONT1, and data control signals CONT2, and then outputs the gate control signals CONT1 to the gate driver 400 and the data control signals CONT2 and the output image signals DAT to the data driver 500.

The gate control signals CONT1 include a scanning start signal STV for instructing the start of scanning and at least one clock signal for controlling an output time of the gate-on voltage Von. The gate control signals CONT1 may further include an output enable signal OE for defining a duration of the gate-on voltage Von.

The data control signals CONT2 include a horizontal synchronizing start signal STH for informing of a beginning of transmission of digital output image signals DAT for a row of pixels PXa and PXb, a load signal LOAD for instructing to apply analog data voltages to the data lines D₁-Dₘ, and a data clock signal HCLK. The data control signals CONT2 may further include a reverse signal RVS for reversing a polarity of the analog data voltages with respect to the common voltage Vcom (hereinafter, a polarity of the analog data voltages will be abbreviated as a polarity of the data voltages).

Responsive to the data control signals CONT2 from the signal controller 600, the data driver 500 receives digital image signals DAT for a row of pixels PXa and PXb from the signal controller 600, converts the digital output image signals DAT into analog data voltages by selecting grayscale voltages corresponding to the output image signals DAT, and then applies the analog data voltages to corresponding data lines D₁-Dₘ.

The gate driver 400 applies the gate-on voltage Von to the gate lines G₁-G₂ₙ in response to the gate control signals CONT1 from the signal controller 600, thereby turning on switching elements Qa/Qb connected to the gate lines G₁-G₂ₙ. The data voltages applied to the data lines D₁-Dₘ are applied to corresponding pixels PXa/PXb through turned-on switching elements Qa/Qb.

The first gate driving circuit 400L and the second gate driving circuit 400R alternately apply the gate-on voltage Von to the odd numbered and the even number gate lines, respectively, and accordingly the first pixel PXa and the second pixel PXb are alternately supplied with the data voltages. The difference between the data voltage applied to the pixels PXa and PXb and the common voltage Vcom becomes a charged voltage of the liquid crystal capacitors Clca and Clcb, that is, a pixel voltage. Alignment of the liquid crystal molecules varies according to the intensity of the pixel voltage, and polarization of light passing through the liquid crystal layer 3 changes according to the alignment of the liquid crystal molecules. The change in the polarization results in a change in transmittance of the light due to the polarizers attached to the liquid crystal panel assembly 300. Thus, the pixels PXa and PXb display a luminance represented by the grayscales of the output image signals DAT.

As described above, the first pixel PXa displays images on the rear surface of the liquid crystal panel assembly 300, corresponding to a side of the liquid crystal panel assembly 300 adjacent an outer surface of the TFT array panel 100, and the second pixel PXb displays images on the front surface of the liquid crystal panel assembly 300, corresponding to a side of the liquid crystal panel assembly 300 adjacent an outer surface of the common electrode panel 200.

By repeating the above-mentioned procedure every 2 horizontal periods (in which 1 horizontal period is equal to one period of the horizontal synchronization signal Hsync and the data enable signal DE), all gate lines G₁-G₂ₙ are sequentially supplied with the gate-on voltage Von, thereby applying the data voltages to all pixels PXa and PXb to display images for the front surface of one frame and images for the rear surface of one frame.

Consequently, two different kinds of pixels PXa and PXb can display images with a different constant phase on the front and rear surfaces of the liquid crystal panel assembly 300. The sizes of the images on the front and rear surfaces do not have to be identical to each other, and may be varied according to design.

When one frame ends, the next frame starts, and a state of the reverse signal RVS applied to the data driver 500 is controlled so that the polarity of the data signal applied to each of the pixels PXa and PXb is opposite to the polarity in the previous frame (frame inversion). At this time, even in one frame, according to the characteristics of the reverse signals RVS, the polarities of the data voltages flowing through the data lines D₁-Dₘ may be inverted (row inversion and dot inversion), and the polarities of the data voltages applied to one pixel row may be different from each other (column inversion and dot inversion).

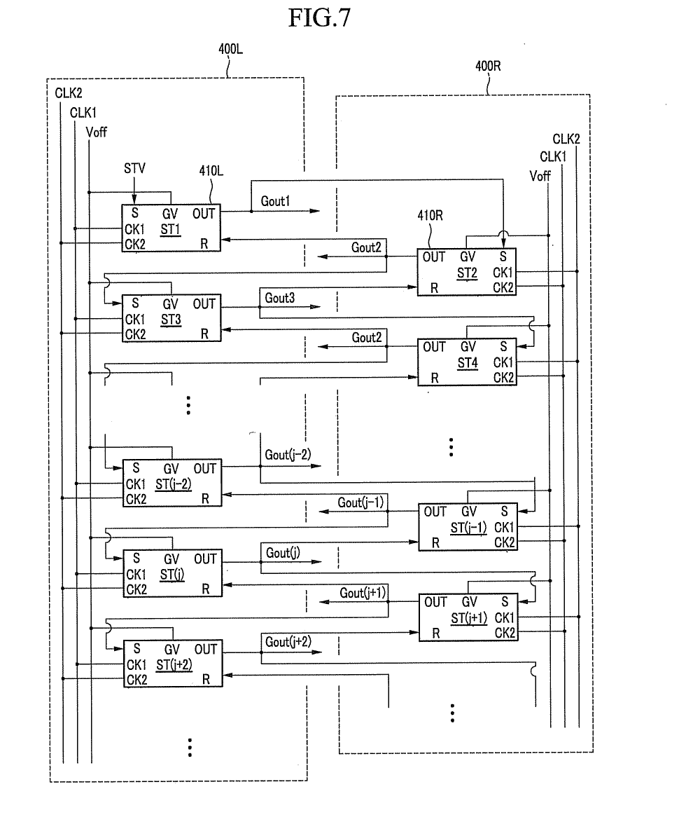

Hereinafter, the gate driver 400 according to an exemplary embodiment of the present invention will be described with reference to FIGS. 7 to 9.

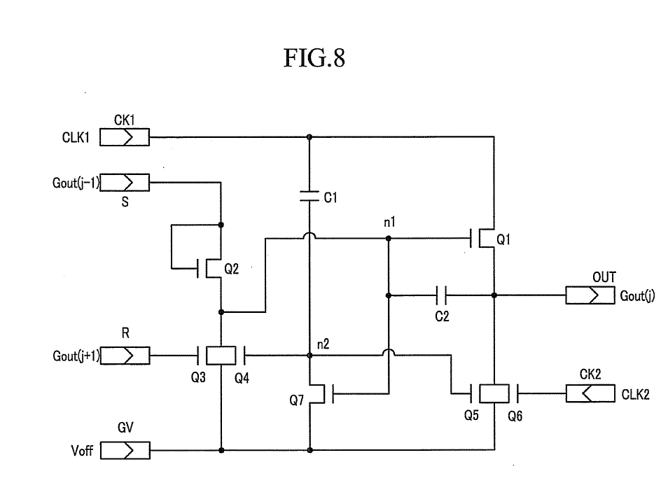

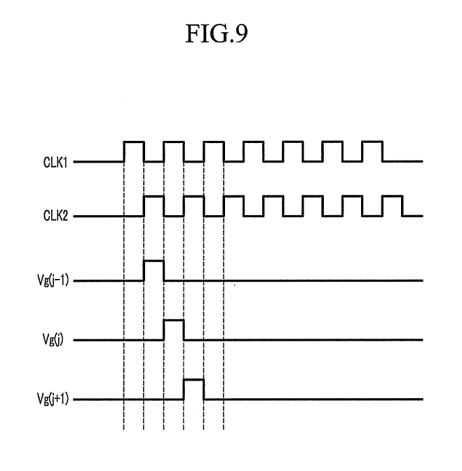

FIG. 7 is a block diagram of an exemplary gate driver according to an exemplary embodiment of the present invention, FIG. 8 is a circuit diagram of one exemplary stage of the exemplary gate driver as shown in FIG. 7, and FIG. 9 is a signal waveform diagram showing the operation of the exemplary gate driver of FIG. 8.

The gate driver 400 as shown in FIG. 7 is a shift register including a first gate driving circuit 400L disposed at the left side of the liquid crystal panel assembly 300 and a second gate driving circuit 400R disposed at the right side thereof, where the liquid crystal panel assembly 300 is not shown in FIG. 7 for clarity. Each of the gate driving circuits 400L and 400R includes a plurality of stages 410L and 410R arranged in a line. The stages 410L are odd-numbered stages [ST1, ST3, . . . , ST (2n−1)] of the gate driver 400 and are included in the first gate driving circuit 400L, and the stages 410R are even-numbered stages [ST2, ST4, . . . , ST 2n] and are included in the second gate driving circuit 400R. The gate driver 400 is applied with a vertical synchronization start signal STV, clock signals CLK1 and CLK2, and a gate-off voltage Voff. The first clock signal CLK1 and the second clock signal CLK2 may be inverted signals with respect to each other, as shown in FIG. 9. A high level voltage of each of the clock signals CLK1 and CLK2 may be identical to the gate-on voltage Von, and a low level voltage thereof may be identical to the gate-off voltage Voff so that the switching elements Qa and Qb of the pixels PXa and PXb can be driven.

Each of the stages 410L and 410R includes a set terminal S, a reset terminal R, a gate voltage terminal GV, an output terminal OUT, and first and second clock terminals CK1 and CK2.

Each of the stages 410L in the first gate driving circuit 400L, for example the j-th stage STj, includes the set terminal S supplied with a gate output of a previous stage ST(j−1), i.e., a previous gate output Gout(j−1), and the reset terminal R thereof is supplied with a gate output of a next stage ST(j+1), i.e., a next gate output Gout(j+1). The clock terminals CK1 and CK2 thereof receive the clock signals CLK1 and CLK2, respectively. The output terminal OUT outputs a gate output Gout(j) to the gate lines G₁, G₃, . . . , G₂ₙ₋₁.

Each of the stages 410R in the second gate driving circuit 400R, for example the (j+1)-th stage ST(j+1), includes the set terminal S supplied with a previous gate output Goutj, the reset terminal R supplied with a next gate output Gout(j+2), and the output terminal OUT outputs a gate output Gout(j+1). However, in contrast with the j-th stage STj in the first gate driving circuit 400L, the first clock terminal CK1 of the (j+1)-th stage ST(j+1) in the second gate driving circuit 400R is supplied with the second clock signal CLK2, and the second clock terminal CK2 thereof is supplied with the first clock signal CLK1.

At this time, the adjacent stages 410L and 410R correspond to different gate driving circuits 400L and 400R, so signal transmission between them can be performed via the gate lines G₁-G₂ₙ. Therefore, each of the stages 410L and 410R is connected to three gate lines G₁-G₂ₙ, such as three successive gate lines, to output a gate output to one of the gate lines G₁-G₂ₙ and supply a previous gate output and a next gate output to the other two gate lines G₁-G₂ₙ.

According to another exemplary embodiment of the present invention, a separate output terminal for outputting a carry signal to be output to previous and next stages may be provided at each of the stages, and a buffer connected to the output terminal OUT may be provided.

In this way, each stage 410L/410R generates the gate output synchronized with the first and second clock signals CLK1 and CLK2 based on the previous gate output and the next gate output. However, the first stage ST1 is supplied with the vertical synchronization start signal STV instead of the previous gate output.

Referring to FIG. 8, each stage of the gate driver 400, for example the j-th stage STj, according to an exemplary embodiment of the present invention includes a plurality of transistors Q1-Q7 and capacitors C1 and C2.

The transistor Q1 has a control terminal connected to a node n1, a first input/output terminal connected to the first clock terminal CK1, and a second input/output terminal connected to the output terminal OUT.

The transistor Q2 has a control terminal connected to the set terminal S, a first input/output terminal diode-connected to the control terminal of the transistor Q2, and a second input/output terminal connected to the node n1.

The transistor Q3 and the transistor Q4 each have a control terminal, a first input/output terminal connected to the node n1, and a second input/output terminal connected to the gate voltage terminal GV, respectively. The control terminal of the transistor Q3 is connected to the reset terminal R, and the control terminal of the transistor Q4 is connected to a node n2.

The transistor Q5 and the transistor Q6 each have a control terminal, a first input/output terminal connected to the output terminal OUT, and a second input/output terminal connected to the gate voltage terminal GV, respectively. The control terminal of the transistor Q5 is connected to the node n2, and the control terminal of the transistor Q6 is connected to the second clock terminal CK2.

The transistor Q7 includes a control terminal connected to the node n1, a first input/output terminal connected to the node n2, and a second input/output terminal connected to the gate voltage terminal GV.

The capacitor C1 is connected between the first clock terminal CK1 and the node n2, and the capacitor C2 is connected between the node n1 and the output terminal OUT.

These transistors Q1-Q7 may be N-type field effect transistors (“FETs”) or P-type FETs. The capacitors C1 and C2 may be a parasitic capacitance between the gate (control terminal) and source/drain (input/output) of the transistors Q1-Q7.

The gate driver 400 including such a stage may be integrated in the liquid crystal panel assembly 300 together with the transistors Qa and Qb of the pixels PXa and PXb and the signal lines G₁-G₂ₙ.

Now, an operation of the exemplary stage as shown in FIG. 8 will be described with reference to FIG. 9.

First, it should be noted that if the j-th stage ST(j) generates a gate output synchronized with the first clock signal CLK1, the previous and next stages ST(j−1), ST(j+1) generate a gate output synchronized with the second clock signal CLK2. Additionally, in this example, it is to be assumed that the high level voltage of the first and second clock signals CLK1 and CLK2 is the same as the gate-on voltage Von, that the low level voltage thereof is the same as the gate-off voltage Voff, and that the transistors Q1-Q7 are turned on depending on the gate-on voltage Von and turned off depending on the gate-off voltage Voff.

First, when the first clock signal CLK1 applied to the first clock terminal CK1 is shifted to a low level and the second clock signal CLK2 applied to the second clock terminal CK2 and the previous gate output Gout(j−1) applied to the set terminal S are shifted to a high level, the transistor Q2 and the transistor Q6 are turned on. Then, the gate-on voltage Von is transferred to the node n1 via the transistor Q2, and accordingly the transistors Q1 and Q7 are turned on via the node n1. The gate-off voltage Voff of the gate voltage terminal GV is transferred to the node n2 via the turned-on transistor Q7, and accordingly the transistors Q4 and Q5 are turned off via the node n2. At this time, since the next gate output Gout(j+1) applied to the reset terminal R is at the low level, the transistor Q3 maintains a turned-off state. In the meantime, since the gate-off voltage Voff is transferred to the output terminal OUT via the two turned-on transistors Q1 and Q6, the gate output Gout(j) at the output terminal OUT becomes the gate-off voltage Voff.

At this time, the capacitor C2 is charged with the voltage corresponding to the difference between the gate-on voltage Von and the gate-off voltage Voff.

Next, when the previous gate output Gout(j−1) applied to the set terminal S and the second clock signal CLK2 applied to the second clock terminal CK2 are shifted to a low level and the first clock signal CLK1 applied to the first clock terminal CK1 is shifted to a high level, the transistors Q2 and Q6 are turned off. At this time, since the next gate output Gout(j+1) applied to the reset terminal R maintains the low level, the transistor Q3 maintains a turned-off state as well. As the transistor Q2 is turned off, the node n1 is disconnected from the set terminal S and enters into a floating state. Accordingly, the transistor Q7 maintains a turned-on state to apply the gate-off voltage to the node n2, and thereby the transistors Q4 and Q5 maintain a turned-off state via the node n2. Since the transistors Q5 and Q6 both enter a turned-off state, the gate-off voltage Voff of the gate voltage terminal GV transferred to the output terminal OUT is disconnected. Since the transistor Q1 maintains a turned-on state, only the gate-on voltage Von, which is the high level of the first clock signal CLK1 applied to the first clock terminal CK1, is transferred to the output terminal OUT and outputted. At this time, since the capacitor C2 maintains a constant voltage, as the voltage of the output terminal OUT increases to the gate-on voltage Von, the voltage of the node n1 in a floating state increases by the increase.

The capacitor C1 is charged with the voltage corresponding to the difference between the gate-on voltage Von of the first clock signal CLK1 and the gate-off voltage Voff, which is a voltage of the node n2.

When the first clock signal CLK1 applied to the first clock terminal CK1 is shifted to a low level and the second clock signal CLK2 applied to the second clock terminal CK2 and the next gate output Gout(j+1) applied to the reset terminal R are shifted to a high level, the transistors Q3 and Q6 are turned on. At this time, since the previous gate output Gout(j−1) applied to the set terminal S maintains a low level, the transistor Q2 maintains a turned-off state. As the transistor Q3 is turned on, the gate-off voltage Voff applied to the gate voltage terminal GV is transferred to the node nil, thereby turning off the transistors Q1 and Q7 via the node n1.

When the transistor Q7 is turned off via the node n1, the node n2 enters into a floating state. At this time, since the capacitor C1 maintains a constant voltage, as the first clock signal CLK1 applied to the first clock terminal CK1 is shifted to a low level, the voltage of the node n2 drops below the gate-off voltage Voff. However, if the voltage of the node n2 drops below the gate-off voltage Voff, the transistor Q7 is turned on again to transfer the gate-off voltage Voff to the node n2. Thus, in the final equilibrium state, the voltage of the node n2 is almost the same as the gate-off voltage Voff. Subsequently, the transistors Q4 and Q5 connected to the node n2 continuously maintain the turned-off state.

In the meantime, since the transistor Q1 is turned off and the transistor Q6 is turned on, the gate-off voltage Voff of the gate voltage terminal GV is transferred to the output terminal OUT and outputted, and the capacitor C2 is discharged.

Thereafter, only the first and second clock signals CLK1 and CLK2 repeat the low level and the high level. However, a change in the level of the first clock signal CLK1 increases the voltage of the node n2 no more than the gate-off voltage Voff, and a change in the level of the second clock signal CLK2 periodically turns the transistor Q6 on and off to merely apply the gate-off voltage Voff to the output terminal OUT periodically. Thus, the voltage of the output terminal OUT continuously maintains the gate-off voltage Voff.

Accordingly, the output terminal OUT of the j-th stage ST(j) can obtain a gate output Gout(j) having the gate-on voltage Von in synchronization with the rising edge of the first clock signal CLK1 applied to the first clock terminal CK1.

After the next gate output Gout(j+1) applied to the reset terminal R is shifted to a low level and hence the transistor Q3 is turned off, the j-th stage ST(j) outputs to the output terminal OUT a gate output Gout(j) maintaining the low level, i.e., the gate-off voltage Voff, regardless of the first and second clock signals CLK1 and CLK2.

That is, when the first clock signal CLK1 applied to the first clock terminal CK1 is at the high level and the second clock signal CLK2 applied to the second clock terminal CK2 is at the low level, the voltage of the node n2 is increased by the capacitor C1 to turn on the transistors Q4 and Q5. Accordingly, the gate-off voltage Voff applied to the gate voltage terminal GV is transferred to the node n1 via the turned-on transistor Q4 so that the transistors Q1 and Q7 maintain a turned-off state. The gate-off voltage Voff applied to the gate voltage terminal GV is transferred to the output terminal OUT via the turned-on transistor Q5 and outputted.

When the first clock signal CLK1 applied to the first clock terminal CK1 is at the low level and the second clock signal CLK2 applied to the second clock terminal CK2 is at the high level, the voltage of the node n2 is dropped by the capacitor C1, thereby turning off the transistors Q4 and Q5. Accordingly, the node n1 maintains the low level, which is the previous voltage, because it is in a floating state, and thus the transistors Q1 and Q7 maintain the turned-off state. The transistor Q6 is turned on to transfer the gate-off voltage Voff applied to the gate voltage terminal GV and output the same via the output terminal OUT.

Therefore, in the subsequent horizontal period, even if the first and second clock signals CLK1 and CLK2 are changed, the gate-off voltage Voff is constantly outputted to the output terminal OUT.

In this way, after generating a gate output in the first stage ST1 to the last stage ST(2n), as a scanning start signal STV2 is inputted into the reset terminal R of the last stage ST(2n), the operation during one frame is finished.

As described above, according to the present invention, different images can be normally realized on both surfaces of the panel by having a pixel driven in a transmissive type and a pixel driven in a reflective type at the LCD device and independently driving the pixels. Additionally, the transmittance can be ensured by the two pixels sharing the storage electrode.

A method of providing images on opposite surfaces of an LCD device is thus made possible, the method including providing transmissive electrodes and reflective electrodes on a first panel, disposing a second panel on the first panel, forming a liquid crystal layer between the first and second panels, and arranging a backlight unit on the second panel to irradiate light towards the first panel, wherein a first image is displayed on an outer surface of the second panel from reflection of light from the reflective electrodes and a second image, different from the first image, is displayed on an outer surface of the first panel from transmission of light through the transmissive electrodes. The method may further include providing data lines and first and second gate lines in the first panel, and connecting the transmissive electrodes to the first gate lines and connecting the reflective electrodes to the second gate lines. The method may further include applying first data voltages to the transmissive electrodes and second data voltages to the reflective electrodes, the first and second data voltages obtained from different image information. Alternate and additional steps and features of a method of providing images on opposite surfaces of the LCD device are also within the scope of these embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel having a first surface and a second surface facing each other, and the display panel including a plurality of first pixels displaying an image on the first surface and a plurality of second pixels displaying an image on the second surface;
a gate driver supplying gate signals to the first and second pixels;
a data driver supplying data signals to the first and second pixels; and
a backlight unit irradiating light on the display panel,
wherein the first pixels and the second pixels can display different images.

2. The display device of claim 1, wherein the first pixels and the second pixels display images in phase.

3. The display device of claim 1, wherein the first pixels and the second pixels are arranged in an alternating fashion.

4. The display device of claim 3, further comprising:
a plurality of first gate lines connected to the first pixels; and
a plurality of second gate lines connected to the second pixels.

5. The display device of claim 4, wherein the gate driver comprises:
a first gate driving circuit applying a gate-on voltage to the first gate lines; and
a second gate driving circuit applying a gate-on voltage to the second gate lines,
wherein the first gate driving circuit and the second gate driving circuit alternately apply the gate-on voltage.

6. The display device of claim 5, wherein the display panel comprises a plurality of data lines connected to the first and second pixels, and
the data driver applies a first pixel data voltage and a second pixel data voltage to the data lines in an alternating fashion.

7. The display device of claim 1, wherein each first pixel comprises a transmissive pixel electrode, and each second pixel comprises a reflective pixel electrode.

8. The display device of claim 7, wherein each first pixel and each second pixel respectively comprise:
a switching device transmitting the data signals in response to the gate signals; and
a liquid crystal capacitor changing polarization of the light from the backlight unit in response to the data signals.

9. A display device comprising:
a display panel having a first surface and a second surface facing each other; and
a backlight unit irradiating light from the first surface of the display panel toward the second surface,
wherein the display panel displays a first image created by transmission of light from the backlight unit on the second surface and a second image created by reflection of light from the backlight unit on the first surface.

10. A liquid crystal display device comprising:
a backlight unit providing light;
a common electrode;
a first pixel electrode facing the common electrode, the first pixel electrode being transparent;
a second pixel electrode facing the common electrode, the second pixel electrode including a reflective material; and
a display panel including a liquid crystal layer formed between the first and second pixel electrodes and the common electrode,
wherein the backlight unit is disposed at a same side as the common electrode relative to the liquid crystal layer.

11. A display device, comprising:
a display panel having a first surface and a second surface facing each other, and the display panel including a plurality of pixels;
a signal processor generating a first image signal to be displayed on the first surface of the display panel and a second image signal to be displayed on the second surface of the display panel; and
a data driver converting the first image signal and the second image signal into a first data voltage and a second data voltage, respectively, to supply the first and second data voltages to different pixels.

12. The display device of claim 11, wherein the pixels are arranged in a matrix, and the data driver supplies the first data voltage and the second data voltage to one pixel row in an alternating fashion.

13. The display device of claim 12, wherein the signal processor comprises:
a first memory unit storing a first set of input image signals inputted from an outside; and
a second memory unit storing a second set of input image signals inputted from the outside,
wherein the first image signal is generated based on the first set of input image signals, and
the second image signal is generated based on the second set of input image signals.

14. The display device of claim 13, wherein the first and second memory units output parts of the first and second set of input image signals in an alternating fashion.

15. A liquid crystal display device comprising:
first and second gate lines arranged in parallel to each other;
data lines intersecting the first and second gate lines;
a first thin film transistor connected to a first gate line and a data line;
a second thin film transistor connected to a second gate line and the data line connected to the first thin film transistor;
a first pixel electrode connected to the first thin film transistor;
a second pixel electrode connected to the second thin film transistor, and the second pixel electrode including a reflective electrode;
a common electrode facing the first and second pixel electrodes; and
a liquid crystal layer formed between the first and second pixel electrodes and the common electrode.

16. The liquid crystal display device of claim 15, wherein the first and second pixel electrodes are disposed between the first gate line and the second gate line.

17. The liquid crystal display device of claim 16, wherein the first and second pixel electrodes are arranged in a data line direction.

18. The liquid crystal display device of claim 17, further comprising a storage electrode line overlapped by the first and second pixel electrodes.

19. The liquid crystal display device of claim 16, further comprising a passivation layer formed between the reflective electrode and the second thin film transistor,
wherein the passivation layer has an uneven surface.

20. The liquid crystal display device of claim 19, wherein the second pixel electrode includes a transparent electrode disposed below the reflective electrode.

21. The liquid crystal display device of claim 16, wherein the first pixel electrode and the second pixel electrode receive data voltages obtained from different image information.
